(19) United States
(12) Patent Application Publication
(10) Pub. No.: US 2005/0198040 A1
(43) Pub. Date: Sep. 8, 2005

(54) Network information management system

(76) Inventors: Michael S. Cohen, Middleton, ID (US); Jeffrey Karl Moeser, Meridian, ID (US); Jonathan C. Weech, Star, ID (US); Glenn Thomas Michael, Boise, ID (US); Justin Robert Mayfield, Boise, ID (US); Amber Gail Jacobs Bedegi, Eagle, ID (US); Gerard Damien Lynch II, Newburyport, MA (US)

Correspondence Address: STOEL RIVES LLP - SLC, 201 SOUTH MAIN STREET, ONE UTAH CENTER, SALT LAKE CITY, UT, 84111, US

(21) Appl. No.: 11/072,787

(22) Filed: Mar. 4, 2005

Related U.S. Application Data
(60) Provisional application No. 60/550,127, filed on Mar. 4, 2004.

(51) Int. Cl. G06F 7/00

(52) U.S. Cl. 707/10

(57) ABSTRACT

A network system installed within a residence provides digital media and simulates a user environment. State devices located throughout a residence generate state data indicative of operation. A state device may be a digital media adapter to allow a non-IP enabled device to receive and play digital media. A server communicates with the state devices to deliver digital media content and to receive state data. The server includes simulation applications that generate a simulated model of the home environment and predict likely events. The server conveys commands to the state devices to take actions to improve the environment for users.

### RELATED APPLICATIONS

The present invention claims the benefit under 35 U.S.C. § 119(e) of U.S. Provisional Patent Application No. 60/550,127, filed Mar. 4, 2004, and titled “Network Information Management System,” which is incorporated herein by specific reference.

### TECHNICAL FIELD

The present invention relates to server and client-based architecture networks and simulation applications modeling real-world events.

### BACKGROUND OF THE INVENTION

A dynamic and accurate model of complex real-world systems is a desired concept in science and engineering. Models may be used to study and make predictions about climate, transportation, epidemics, economies, and computer systems, both real and imagined. Models represent the state of and allow control over complex artifacts, such as aircraft, nuclear reactors, and an internal combustion engine.

The various systems and applications developed for use in networked home environments have generally treated data sources and control interfaces in isolation from other applications. Some attempts have been made to integrate applications. For example, a system may patch security camera images into television distribution systems and allow “doorbell cam” to interrupt movie viewing. These attempts are often ad hoc and do not provide the infrastructure needed to address higher-level user needs. Such systems are further incapable of providing realistic models of an environment and take action to effect a predicted outcome. Thus, it would be an advancement in the art to provide a network system that comprehensively integrates subsystems, generates a model of the environment, predicts outcomes, and generates actions to achieve desired results and enhance the quality of the environment. Such a system is described and claimed herein.

### BRIEF DESCRIPTION OF THE DRAWINGS

Non-limiting and non-exhaustive embodiments of the present invention are described in the Figures, in which:

FIG. 1 is a block diagram illustrating an embodiment of a server.

FIG. 2 is a block diagram illustrating an embodiment of a digital media adapter.

FIG. 3 is a block diagram illustrating an embodiment of a network system.

FIG. 4 is a conceptual diagram illustrating an embodiment of a simulation module.

FIG. 5 is a conceptual diagram illustrating operation of state devices in a network system.

FIG. 6 is a conceptual diagram illustrating a system architecture.

### DETAILED DESCRIPTION

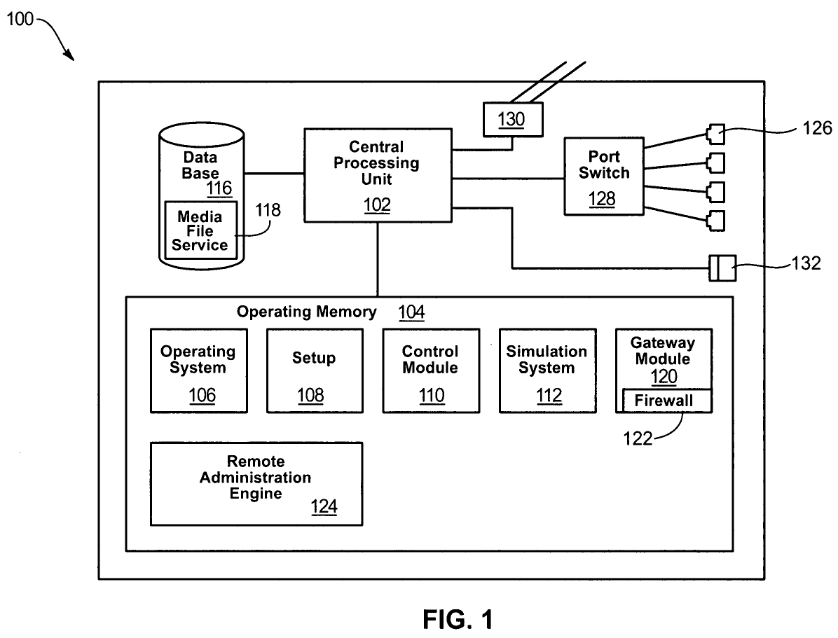

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 6, is not intended to limit the scope of the invention, as claimed, but is merely representative of presently preferred embodiments of the invention.

A network system is an integrated set of computing, storage, and networking components that hosts all of the applications required to implement an intelligent networked home and its associated mobile and personal extensions. The network system has application to a residential environment as well as business and commercial applications. The system includes software routines that are hosted on an appropriately scaled network of computing resources. The software routines acquire state data from sensors and databases. The system supports a super-application layer and advanced human interface objects that represent to various classes of users unified, coherent, permission controlled views of and control over the home/lifestyle information environment.

The network system is embedded in residential and commercial structures and their mobile extensions, such as vehicles and portable electronic devices. The system manages both the physical environment and the “infosphere” for the benefit of owners, occupants, and service providers. Applications responsible for specific data elements also pass element values and meta-data to cross-domain agents and super applications instantiated on various computing nodes attached to the system locally or remotely.

The various subsystems, applications, and agents are organized to implement a simulation model that represents all of the available data and meta-data available for creating predictions, explanations, alerts, and advisories. Users with defined roles and permissions interact with appropriate data abstractions offered by multiple UI instances on devices ranging from televisions to wall switches.

The system includes a simulation module that models the lifestyle information environment. The simulation module provides a predictive and explanatory model of real life events, including data abstractions representing real-world states and meta-data describing states of communications and entertainment data streams. The simulation model may consider the state of numerous devices. These devices, both internal and external to a residence, include light switches, thermostats, health monitors, image sensors, air quality sensors, water quality sensors, port of entry for audio/video streams, weather input, irrigation systems, and HVAC (Heating, Ventilating and Air Conditioning).

The system acquires state data from the control and sensor devices and organizes the state data. The simulation module includes a number of rules and scenarios to which the state data is applied. The simulation module generates responses to the devices to control their performance and enhance the lifestyle of a user.

Human users and higher level software agents interact with the simulation module to view operation, rules, and states. Human users and software agents are granted roles, views, and permissions. Human users and software agents are provided with secure and appropriate access to different user classes. Users and agents are able to modify rules and set preferences to alter the performance of the simulation module.

The system is designed to connect residential and commercial structured wiring networks with applications, such as RG (Residential Gateway), digital media server, home automation controller, and with external resources including telephone, cable television, broadband Internet, and satellite television. The system is designed to fit the structured wiring panel environment with consideration of form factor, power, thermals, I/O (Input/Output) facilities, user and installer interfaces, upgrade and maintenance strategies.

Structured wiring installations provide network resources for delivering information and control functions in the home. A location for hosting a set of home automation and media distribution applications is a wiring hub where the various service inputs are collocated with the terminals of the structured wire runs. A modular server system that meets the form factor and environmental constraints of the hub may be used versus a typical office PC hosting similar functions because it is embedded, reliable, and resources are controlled. The system is able to expand in a modular fashion. The expandability is provided by multiple computing elements and kernel images that scale to an application load and may be upgraded in the field without disrupting existing configuration.

Referring to FIG. 1, a block diagram of an embodiment of a server 100 for operating a simulation model and hosting digital media is shown. The server 100 may operate as a central node located at a confluence of services and distribution links. The server 100 may further provide network management and Internet connectivity within a residence or office. The server 100 provides a hub from which to deploy network, storage, multimedia applications, and content.

The server 100 includes a central processing unit 102, such as an Intel IXP-42X XScale network processor or equivalent embedded X86 processor. The processing unit 102 is in electrical communication with an operating memory 104 that may be embodied collectively as RAM (Random Access Memory), ROM (Read Only Memory), flash memory, and the like. The operating memory 104 includes applications to operate the server 100 including a secure embedded operating system 106. The operating system 106 may be embodied as an Intel IXP42X or X86 processor based. Alternatively, the operating system 106 may include Linux Kernel 2.4.2 or greater, RedHat, uCLinux, or equivalent. The operating system 106 may be full-core enabled including all file system, network, and protocol stacks. The operating system 106 may further include full ported functionality for Intel IXP42X (xscale) support and patches.

The operating memory 104 may include an automatic wizard setup 108 from Microsoft Windows 9x/2000/XP Client PC's or other comparable devices. The automatic wizard setup 108 allows a user with little or no network experience to initiate the setup. The wizard setup 108 may support scalable interface complexity.

The operating memory 104 further includes an automated control module 110 to operate state devices of a network and a simulation module 112 to predict and react to conditions based on state data. The operating memory 104 also includes a user interface “UI” 114 to enable user control of the server 100, digital media adapters, and other processing modules on a network. The UI 114 is preferably simple and intuitive to provide “one glance” user understanding and may be created and deployed using common tools that function across platforms and operating systems. The UI 114 conveys system status and other useful information. The UI 114 may include HTML (Hyper-Text Markup Language), XML (extensible Markup Language) abstractions of core application APIs (Application Programming Interfaces) and media/content rich tools where needed, such as Java and Flash. The UI 114 may be navigation independent of a pointing device to allow the UI 114 to be equally at home with remote, mouse, keyboard, or buttons on the front of a digital media adapter device.

The operating memory 104 may include additional APIs and applications to facilitate server function. The applications may be available through the UI 114 that can be accessed from a browser of a personal computer or other browser-enabled device, a digital media adapter, discussed below, and in some cases through a native UI of a connected network device. Applications may be delivered through separate code bases functioning independently under the UI 114.

The processing unit 102 is further in electrical communication with a database 116 for centralized storage of digital media. The database 116 may be embodied as a non-volatile memory and may be a partition of the operating memory 104. The server 100 seamlessly distributes the digital media to compatible devices throughout a network. The digital media is thereby accessible from any network device in communication with the network. The database 116 includes a media file server 118 that supports storage, cataloging, and distribution of multiple media file categories and formats. The file server 118 may include an integrated front-end or player application that supports general browser-based deployment. The file server 118 may further provide support for a multiple client/server environment. The file server 118 may also include an embedded CODEC (enCoder/Decoder) within the system architecture. The file server 118 may include an open upgrade path for the addition of CODECs, DRM (Digital Rights Management) engines, new player applications, and the like. The file server 118 may support Windows, Unix/Linux, and MAC (Apple Macintosh) file sharing protocols. The file server 118 may provide full isolation of digital media from the Internet. The file server 118 may provide fully addressable network attached storage and protected application storage partition.

The operating memory 106 includes a network gateway module 120 that enables Internet and network connectivity. The gateway module 120 is front-end, back-end, and database configurable and GUI (Graphical User Interface) agnostic. The gateway module 120 provides networking and Internet sharing functions including any of the following: automatic configuration of WAN (Wide Area Network) port/client via wizard based setup script; support for WAN DHCP (Dynamic Host Control Protocol) client fixed/support for WAN DHCP Client, Fixed/Static IP (Internet Protocol), and PPPoE (Point-to-Point Protocol over Ethernet); MAC (Media Access Control) Cloning or configuration for service providers that require a particular MAC address; and standard IP configuration fields for fixed IP installations, such as ISP (Internet Service Provider) assigned IP address, ISP subnet mask, ISP Internet Gateway, ISP primary and secondary DNS (Domain Name Server) servers, and MTU (Maximum Transfer Unit) adjustment best performance from broadband provider. The gateway module 120 may support LAN (Local Area Network) connectivity including: up to 253 simultaneous connections/clients (fixed address, DHCP, or Mixed); configurable DHCP server; hardware physical IP address; dial-up Internet access support; high speed internet access support; Ethernet port; full data isolation from LAN; and client DHCP on WAN port.

The gateway module 120 may support wireless access with IEEE 802.11g for wireless LAN. The gateway module 120 may provide different data rates per channel with auto fallback or a fixed data rate option. The gateway module 120 may include a multimode operation with on, off, and an extended AP (wireless Access Point) swarm that creates a whole residence home wireless footprint by using AP repeaters. The gateway module 120 may support encryption options including none, 64-bit, 128-bit, and 256-bit WEP (Wireless Encryption Protocol). The gateway module 120 may employ a user authentication engine that supports ASCII (American Standard Code for Information Interchange) or HEX (Hexadecimal) key entry with auto translation.

The gateway module 120 may include a firewall application 122 with network address translation. The firewall protection may include VPN (Virtual Private Network) passthrough, virtual server functionality, and full stealth capability on privileged ports. The firewall application 122 may include a built-in masquerading table for email, HTTPS (Hyper-Text Transfer Protocol-Secure) for non-proxy mode browsers, instant messenger services, and telnet. The firewall application 122 may further include functionality for MAC (Media Access Control) filtering, IP filtering to grant/deny privileges based upon IP address, URL (Universal Resource Locator)/domain based filtering to grant/deny access based upon specific URL or top level domain, and a gaming mode to establish DMZ (De-Militarized Zone) IP addresses for unfettered Internet access required by many game applications.

The server 100 may include a remote administration engine 124 for remote user access and administration. When addressing from outside a network, a remote user may hit static IP or DDNS (Dynamic Domain Name Service) IP of the system and a port trigger. The remote administration engine 124 is mapped to all internal functions and standard user interface to make functions available.

The server 100 may be upgraded by a remote Internet based http or FTP (File Transfer Protocol) methodology administered through a web interface. In a pull scenario, a user or installer initiates contact from a resident UI and proceeds with upgrade or provisioning. In a push scenario, after installation and system registration, a head end/hosted application initiates contact with the server 100 and proceeds with upgrade, provisioning, and health monitoring.

For network communication, the central processing unit 102 may be in electrical communication with a network interface, such as one or more WAN/LAN ports 126. The ports 126 may be accessed by the central processing unit 102 through a port switch 128. For wireless communication, the central processing unit 102 may be in electrical communication with a wireless LAN device 130. The server 100 may further include a USB (Universal Serial Bus) port 132 in electrical communication with the central processing unit 102 or other ports known in the art. The server 100 may interface with input and output devices through ports or wireless connections. Alternatively, the server 100 may include conventional input and output devices to enable user communication.

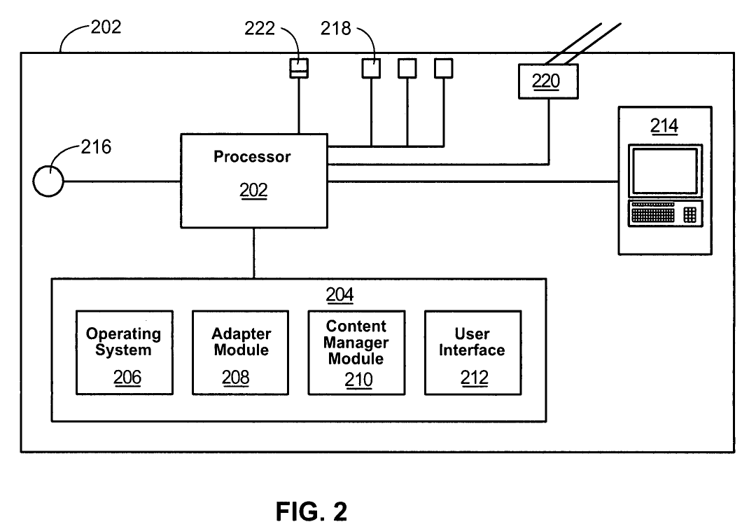

Referring to FIG. 2, a block diagram of one embodiment of a digital media adapter 200 is shown. Computing nodes, sensors, controls, network links are part of a network system infrastructure. However, not all devices in a system are conventionally enabled for digital media. The digital media adapter 200 provides access to centralized content and software applications and creates a bridge between an Ethernet network facilitated by a building's structured wiring and an embedded gateway of a server 100. This allows digital music, video content, collected images, and software applications to be accessible from non-IP enabled electronic devices such as televisions, HDTV (High Definition TeleVision) monitors, audio tuners/amplifiers, and whole home audio installations. The digital media adapter 200 delivers the full functions of a user interface, while delivering additional functionality for A/V (Audio/Video) applications suited to consumer electronics devices.

The digital media adapter 200 includes a processor 202 that may be an X86 processor, an embedded MIPS/ARM (example microprocessor architectures), or the like. The processor 202 is in electrical communication with a memory 204 which may be embodied separately or collectively as ROM, RAM, non-volatile, flash, and the like. The memory 204 includes an embedded, secure operating system 206 that facilitates adapter function.

The digital media adapter 200 further includes an adapter module 208 that converts received digital audio, digital video, and digital photo/picture distribution into legacy audio and video devices, such as audio amplifiers, televisions, large format HDTV monitors or projectors, and distributed audio installations. The adapter module 208 may include a combination of hardware and software to perform its functions. The adapter module 208 supports multi-format streaming and MP3, WMA, VOB, WAV (audio file format acronyms) and sub formats of each. The adapter module 208 includes full component audio like control, such as play, pause, fast forward, rewind, stop, skip forward, and skip backward. The adapter module 208 is able to function as a multi-format streaming video receiver and supports MPEG 4, DIVX, MPEG 1, MPEG 2, AVI, and Native DV-AVI (video file format acronyms). The adapter module 208 provides full screen and full frame rate video, contingent upon encode quality and format and decode engine used, and full VCR-like control. The adapter module further supports a photo/image viewer for JPEG, TIFF, GIF, BMP, MPEG, PNG (image format acronyms), and other formats.

The memory 204 may further include a content manager module 210 that includes automated discovery, collection, and cataloging of digital media within a network. Discovered digital media is made available through any connected digital media adapter 200.

A digital media adapter 200 supports device and network discovery, such as full plug and play connectivity and automated discovery. Accordingly, install and setup time is reduced because devices already have a pre-established path to handshake.

The memory 204 may include a user interface 212 to enable user control of the adapter 200 to access digital media. Through the user interface 212, a user may access and control other devices within a network as well. For example, a user may adjust HVAC (Heating, Ventilation and Air Conditioning) controls and then select digital media content.

The digital media adapter 200 includes a user interface device 214, in electrical communication with the processor 202 to enable user input and output. The interface device 214 may include a keyboard, touch pad, pointing device, display, and a remote control interface. The display may be embodied as an LCD (Liquid Crystal Display), or other suitable display, for information and navigation purposes. The user interface 212 delivers output to a user through the interface device 214 and may be based upon standard markup, reference, and display languages and tools, such as HTML and XML. The user interface 212 may include a common API that allows for the easy integration of new functions and applications. New applications may be delivered through separate code bases functioning independently under the user interface 212. The user interface 212 may provide a customizable play list of digital media available from the database 116.

The digital media adapter 200 includes one or more output ports 216 that are in electrical communication with the processor 202 and are configured to couple to non-IP enabled electronic devices, such as televisions, HDTV monitors, and audio tuners/amplifiers. As such, the output ports 216 may be implemented in various ways to enable communication. The digital media adapter 200 further includes LAN/WAN network ports 218 to enable communication with a network. The adapter 200 may include a wireless LAN device 220 for wireless network connection and a USB port 222.

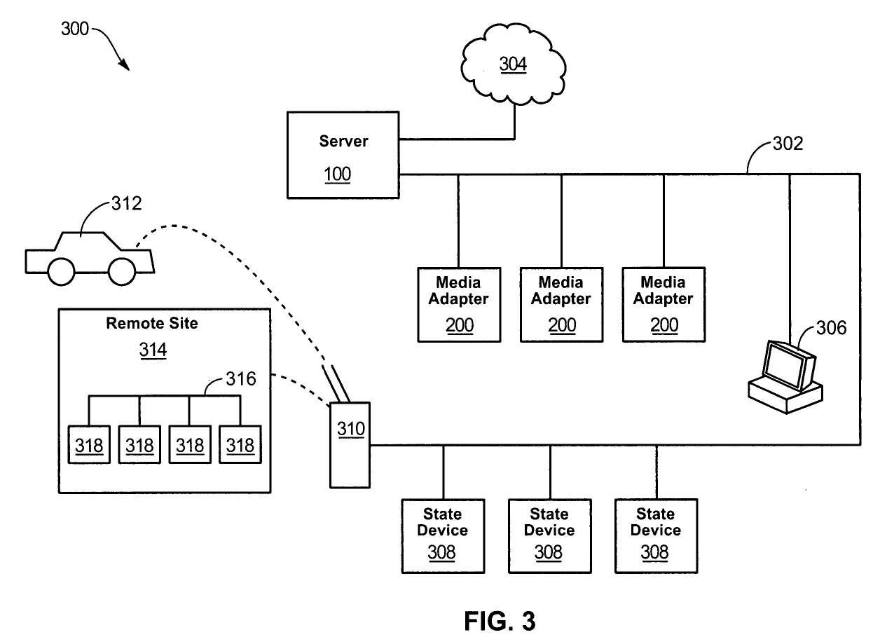

Referring to FIG. 3, an embodiment of a network system 300 to distribute digital media network connectivity to IP and non-IP devices is shown. The network system 300 further provides a simulation model to monitor, predict, and react to lifestyle events within a residence. One of skill in the art will appreciate that the system 300 is provided as only one embodiment and any number of alternative implementations and techniques are within the scope of the invention. Thus, the system 300 may include hardware devices, interconnect protocols, module implementations, industrial design details, and external interfaces common to networks. The system components are built for installation as the intelligent, activating elements of a structured wiring/wireless home network.

The network system 300 includes a server 100 that is in electrical communication with a network 302 that may be wired, wireless, or a combination. The server 100 may be in electrical communication with a WAN or the Internet 304 directly or through the network 302. The system 300 includes one or more digital media adapters 200 that are in communication with the network 302 to receive digital media from the server 100. The digital media adapters 200 further transmit state data regarding their present state of operation to the server 100. Digital media adapters 200 may be deployed in a “X:1” relationship with the server 100 functioning as the core repository and distribution mechanism for digital media. In this manner, the digital media adapter 200 serves as the end of a wire/wireless distribution point for the conversion and consumption of the digital media.

The network system 300 may further include IP enabled devices 306, such as personal computers, that are able to receive digital media from the server 100 without the conversion capability of a digital media adapter 200. The IP enabled devices 306 include suitable player and browser applications to play the digital media. The IP enabled device 306 is able to support simultaneous distribution of audio and video streams to multiple digital media adapters 200 and IP enabled devices 306.

The network system 300 further includes one or more state devices 308 that are in electrical communication with the server 100. The state devices 308 include sensors, controls, actuators, and alarms that generate state data relating to their operation or the physical world. The state devices 308 may include digital media adapters 200 and IP enabled devices 306 to the server 100. A state device 308 may include controls for HVAC, home security, utilities, irrigation, telephony, Internet access, and the like. State devices 308 may be disposed throughout the internal and external structure of a residence to monitor and control an environment. State data is transmitted to the server 100 and processed in accordance with the simulation module 112 to analyze, predict, and react to a user's environment.

In addition to being installed throughout a residential or commercial structure, the network system 300 may extend through a wireless interface 310 to vehicles 312, such as automobiles. The vehicle 312 may be equipped with one or more state devices 308 to relay state data to the server 100. The server 100 is able to operate the state devices 308 in accordance with user preferences or based on determinations by the simulation module 112. The network system 300 may be further extended to include sites 314, such as offices, hotel rooms, secondary homes, that are remote from a residence. Each remote site 314 may include a LAN 316 with remote state devices 318 that are in electrical communication with the server 100. The remote state devices 318 relay remote state data to the server 100 and may be operated to influence the environment of a remote site.

By way of example, a hotel room may include a local network, local state devices, and network connectivity. When a user arrives, the local network may be placed in electrical communication with a network system 300. The network system 300 may monitor the local state devices and operate their use in conformance with user preferences and a schedule in order to meet a user's health and security requirements. In another embodiment, a user may carry a portable processing device, such as a PDA (Personal Digital Assistant), laptop, or the like which informs the network system 300 as to the user's location. When a user enters a hotel room, rental home, or other temporary dwelling, the user may have the portable processing device integrate with a local network. In so doing, the local network may be placed in electrical communication with the network system 300. The network system 300 may upload user preferences and schedules or may monitor and update the local network.

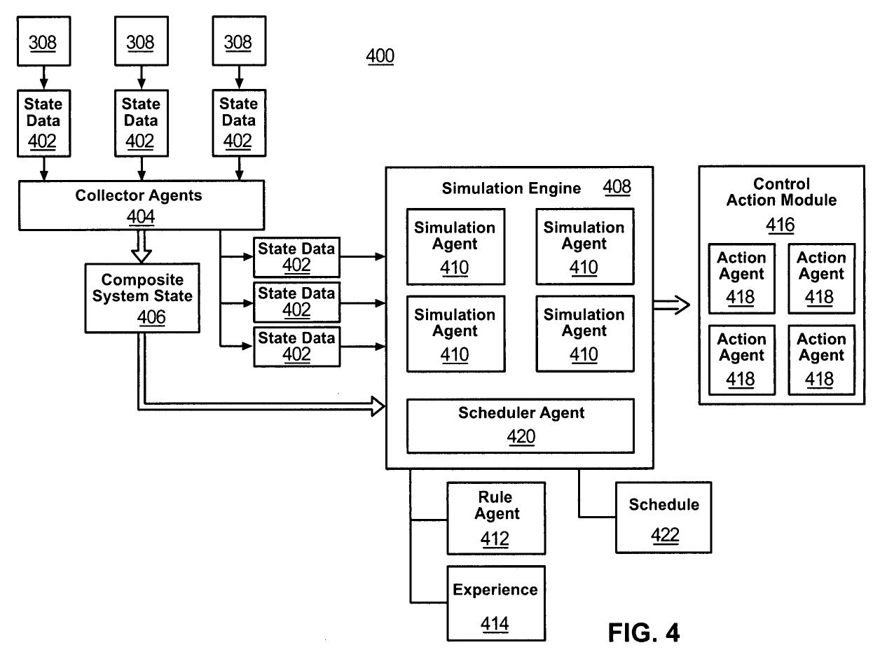

Referring to FIG. 4, a block diagram of an embodiment of a simulation module 400 is shown. The simulation module 400 may be resident within the server 100 or discretely separated amongst different devices within a network system. The simulation module 400 receives state data 402 from the various state devices 308. The state data 402 may include the combined states of objects representing sensors, controls, actuators, and alarms that are distributed in a residence, all of the content streams entering a residence, all the saved content resident on servers, personal computers, and media players, all service products in use from telecom, cable, or web-based providers, all personal schedules and plans logged on various smart devices, data transmitted from automobile or other mobile extensions of the residence, data from remote sites, any linked states of office, friends, relatives, and any advice or information provided by professional contractors. In addition to a residence, the state devices may be deployed throughout commercial and office buildings. Thus, state data 402 may include abstractions of state of devices within a user's environment including residential and occupational.

The state data 402 is assimilated by collector agents 404 that determine a composite system state 406 which includes abstractions of physical reality, such as weather data, home control systems status, security camera images, as well as ordinary data objects, such as files and streams. The state data 402 may further include meta-data describing digital music and movies. The agents 404 have cross-domain capability to monitor different subsystems of a network system. For example, the agents 404 monitor security, local weather forecast, lighting, fire alarms, and irrigation control. Based on the weather forecast, the state of irrigation control may be modified. Depending on the states of security devices, home lighting may be adjusted. In this manner, the simulation module 400 integrates separate subsystems and locates intelligence at the nexus of the interconnection resources in a residence. The agents 404 generate a composite system state 406 and develop meaningful interrelationships between content and states that are typically uncoordinated. The agents 404 operate together to provide a superior simulation due to interrelated state data.

The composite system state 406, interrelationships, and state data 402 is conveyed to a simulation engine 408 that analyzes input to meet desired objectives and achieve accident avoidance. The simulation engine 408 includes simulation agents 410 that generate separate simulation models. The simulation agents 410 predict and prognosticate outcome based on events and considers action to provide a desired outcome. Simulation agents 410 may operate based on fuzzy logic and access to a rule tree 412 and outcome experience 414.

Simulation agents 410 may individually be assigned to different aspects of a user's residential and occupational environment. Simulation agents 410 may include safety, comfort, schedule, and aesthetics. Each simulation agent 410 addresses its objectives and further integrates objectives of other agents. The simulation engine 408 provides unified system modeling in the form of the simulation agents 410 which predict future events based on a unified view of operations.

The simulation engine 408 outputs recommendations to a control action module 416 that includes action agents 418 that generate specific actions to state devices 318 within the network system 300. The simulation module 400 operates to hide complexity from users. Action may be taken as an autonomous loop, may advise a user as action is taken, or may request authorization from a user prior to taking action.

The simulation engine 408 may further include a scheduler agent 420 that monitors a schedule 422 based on user inputs and system states. The scheduler agent 420 coordinates state data 402 with the schedule 422 to ensure compliance. When state data 402 indicates non-compliance, the scheduler agent 420 may provide notification through a user interface to a user. The schedule 422 may include one-time events or routinely repeated events.

In one example, the schedule 422 includes a desired number of exercise hours for a week. An exercise machine may be embodied as a state device 318 providing state data 402 to the simulation engine 408. The scheduler agent 420 may monitor the exercise machine to record the time amount of use. Alternatively, a user may enter the amount of time exercising when a user does not incorporate a state machine into an exercise regime. The scheduler agent 420 may provide periodic reminders to the user as weekly exercise deficits are noted. Reminders may be displayed on any state device 318 with a suitable user interface device.

In another example, a scheduler agent 420 may monitor dispersals from a medicine dispenser. The medicine dispenser may be embodied as state device 318 that generates state data 402 reflecting dispersals. The scheduler agent 420 compares the dispersals against a prescription schedule. If the dispersals do not comply with the schedule, the scheduler agent 420 may provide notice to a user. In this manner, a user receives timely notice of critical scheduled events that may impact a user's health. Such notice may be provided not only within a residential network, but also to remote sites and vehicles where appropriate.

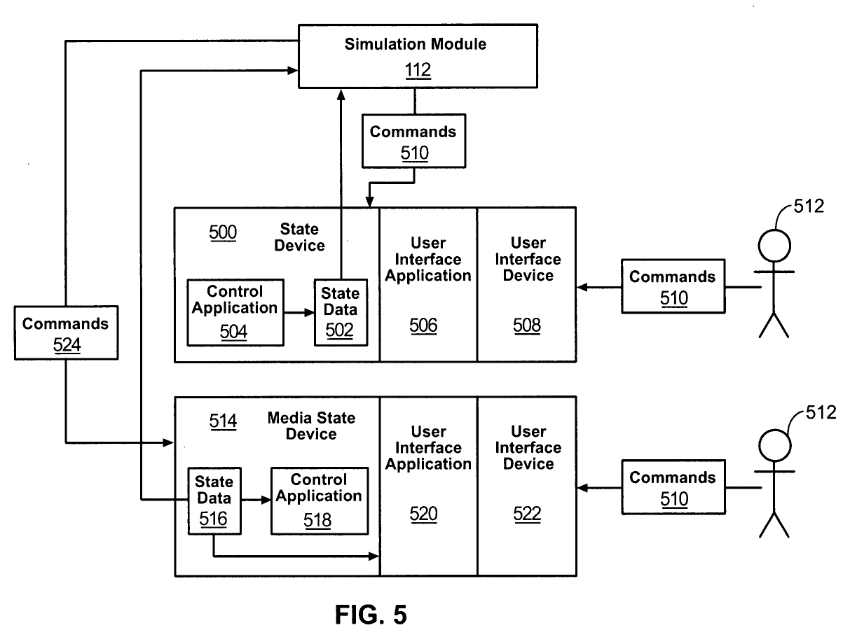

Referring to FIG. 5, a block diagram conceptually illustrating the relationship between state devices and the simulation module 400 is shown. In one example, a state device 500 may be a thermostat that controls a furnace. The state device 500 generates state data 502 that reflects ambient temperature and a furnace setting. The state device 500 includes a control application 504 that conveys the state data 502 to the simulation module 112. The state device 500 may further include a user interface application 506 that operates a user interface device 508. The user interface application 506 interprets the state data 502 and may instruct the user interface device 508 to display output. User interface devices 508 include a wide variety of devices ranging from personal computers and tablets to simple switches and indicators. User interface applications 506 and devices 508 allow the monitoring and interacting with the modeled environment.

A thermostat may display the current ambient temperature and the furnace setting. The control application 504 may automatically adjust a furnace setting without requiring user authorization, but also provide user notification. The user interface application 506 and device 508 allows a user 512 to input a different furnace setting as desired. Input commands 510 either from the simulation module or from a user 512 are conveyed to the control application which operates the state device 500 accordingly.

Another state device 514 may be embodied as a media state device to receive and play digital media. The media state device 514 conveys meta-data 516 reflecting the digital media to a control application 518. The meta-data 516 is conveyed to the simulation module 112 so that the module 112 is appraised of the content at the media state device 514. The meta-data 516 is further conveyed to a user interface application 520 and to a user interface device 522. The user interface application 520 interprets the meta-data 516 and generates displayable content, such as play lists, currently played media, and so forth. A user 512 enters input into the user interface device 522, such as selected media, advance, reverse, skip, and the like. Input commands 524 either from a user or from the simulation module 112 are conveyed to the control application 518.

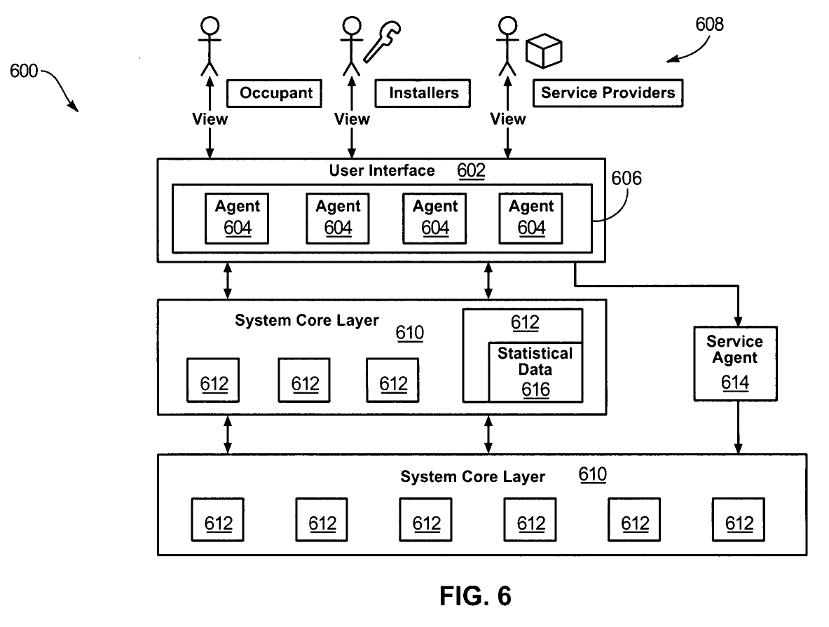

Referring to FIG. 6, a block diagram illustrating an embodiment of system architecture 600 of applications resident in a server. The system architecture 600 includes a user interface 602 having agents 604 that may be deployed in a super-application layer 606 to manage the user interface experience to meet specific needs. Synthesizing cross-domain information to provide more insight into a complex situation is different than constraining the possible view and control actions of a user. The super-application layer 606 of the system architecture can perform functions without disturbing the internal workings of application objects or the user interface objects.

Users 608 are illustrated, which are external actors that have relationships to the simulation module 112. The term “users” is used generically to refer to individuals or systems that interact with a given system via its external interface. Users include installers, services providers, residential occupants, such as family and friends, and proxies. The users may interact with the user interface 602 using a variety of devices capable of rendering user interface objects. Users 608 are assigned hierarchal permissions that govern access. By way of example, a residential owner may receive the most access and permissions. A babysitter may receive some access. A service provider may receive limited access to one or more modules to provide upgrades or even additional modules. A service provider may be granted access to monitor the status of propane tanks or other utilities.

An installer may require access to all system core layers 610 and modules 612 for installation and maintenance. A residential owner may be limited from accessing certain layers 610 and modules 612 to prevent damage to the architecture 600. Service providers may require privileged access to certain modules 612 for updates. The modules 612 include functions that control access to encrypted data, distribute updates to proprietary billing and service modules, manage network security, contract maintenance, as well as many other functions. Providers may maintain management consoles for special access requirements. Users 608 with appropriate permissions may view and control modules 612 either directly or through an intermediary agent. Less privileged permissions may enable a user 608 to use a service agent 614 that can manage views and controls of a module 612 to thereby constrain access.

In one implementation, a service provider may be limited to access one or more modules 612 to not only provide updates and services but also retrieve user statistics 616. A module 612 may compile user statistics during routine operations. The user statistics 616 may include non-traceable information regarding a variety of user attributes and habits. The service provider may sell the non-traceable information to entities compiling statistical data. For example, the user statistics 616 may include user profiles, selected digital media, on-line purchases, or other consumer preferences. As the information is non-traceable, the privacy of a user is not compromised.

A network system provides digital media distribution and implements a simulation of a residential and occupational environment. The network system is embedded in structures through wired and wireless extensions and interfaces as well as mobile extensions, such as vehicles and portable electronic devices. A simulation module acquires state data from state devices for processing by a simulation engine. Based on state data, database information, experience, rule trees, and user preferences. Users have associated permissions to control access and views over core modules of the system. Cross-domain agents are able to provide superior simulated modeling and control of state devices to enhance an environment.

While specific embodiments and applications of the present invention have been illustrated and described, it is to be understood that the invention is not limited to the precise configuration and components disclosed herein. Various modifications, changes, and variations apparent to those of skill in the art may be made in the arrangement, operation, and details of the methods and systems of the present invention disclosed herein without departing from the spirit and scope of the present invention.

1. A network server to distribute digital media over a network and simulate an environment, comprising:
a processor;
a memory in electrical communication with the processor and including,
an operating system,
a user interface to enable user communication, and
a simulation module to perform a method of,
generating a simulated model of an environment,
receiving state data over the network corresponding to state devices in communication with the network,
generating actions to the state devices based on the state data to effect operation of the state devices;
a database in electrical communication with the processor and having,
digital media stored thereon for distribution over the network, and
a media file server to access the digital media; and
a network interface in electrical communication with the processor to enable communication with the network.

2. The network server of claim 1, wherein the memory includes a gateway module to interface with the network.

3. The network server of claim 2, wherein the gateway module includes a firewall application.

4. The network server of claim 1, wherein the memory includes a remote administration engine to enable remote user control.

5. The network server of claim 1, wherein the network interface includes a LAN port.

6. The network server of claim 1, wherein the network interface includes a wireless LAN device.

7. The network server of claim 1, wherein the simulation module comprises,
collector agents to receive state data and generate a composite system state;
a simulation engine including simulation agents to receive composite system state and state data and generate recommendations; and
a control action module including action agents to receive recommendations and generate actions for state devices.

8. The network server of claim 7, wherein the simulation engine includes a scheduler agent for performing the method of,
receiving state data indicative of operation of a state device;
comparing the state data to a schedule; and
generating an output to notify a user of noncompliance with the schedule.

9. A network system providing digital media and simulating an environment, comprising:
a plurality of state devices generating state data indicative of a state of operation, wherein at least one state device is a digital media adapter to convert digital media for a non-IP enabled device; and
a server in electrical communication with the state devices, including
a processor,
a memory in electrical communication with the processor and including,
an operating system,
a simulation module to perform a method of,
generating a simulated model of an environment,
receiving state data over the network corresponding to the state devices,
generating actions to the state devices based on the state data to effect operation of the state devices, and
a database in electrical communication with the processor and having digital media stored thereon for distribution to the digital media adapter.

10. The network system of claim 9, wherein at least one state device is an IP enabled device to receive digital media.

11. The network system of claim 9, wherein the memory of the server includes a gateway module to interface with the network.

12. The network system of claim 11, wherein the gateway module includes a firewall application.

13. The network system of claim 9, wherein the memory of the server includes a remote administration engine to enable remote user control.

14. The network server of claim 9, wherein the simulation module comprises,
collector agents to receive state data and generate a composite system state;
a simulation engine including simulation agents to receive composite system state and state data and generate recommendations; and
a control action module including action agents to receive recommendations and generate actions for state devices.

15. The network server of claim 14, wherein the simulation engine includes a scheduler agent for performing the method of,
receiving state data;
comparing the state data to a schedule; and
generating an output to notify a user of noncompliance with the schedule.

16. A network server to distribute digital media over a network and simulate an environment, comprising:
a processor;
a memory in electrical communication with the processor and including,
a plurality of modules, wherein one of the modules is a simulation module to generate a simulated model of an environment, and
a user interface to enable user communication and perform the method of,
reviewing a permission assigned to a user, and
limiting access to the modules based on the permission;
a database in electrical communication with the processor and having,
digital media stored thereon for distribution over the network, and
a media file server to access the digital media; and
a network interface in electrical communication with the processor to enable communication with the network.

17. The network server of claim 16, wherein the user interface further performs the method of,
enabling a user to access, based on permission, a module generating non-traceable statistics; and
allowing the user to retrieve the non-traceable statistics based on permission.

18. The network server of claim 16, wherein the memory includes a remote administration engine to enable remote user control.

19. The network server of claim 16, wherein the simulation module comprises,
collector agents to receive state data from state devices;
a simulation engine to receive the state data and generate recommendations; and
a control action module to receive recommendations and generate actions for state devices.

20. The network server of claim 16, wherein the simulation engine includes a scheduler agent for performing the method of,
receiving state data indicative of operation of a state device;
comparing the state data to a schedule; and
generating an output to notify a user of noncompliance with the schedule.

21. A network system providing digital media and simulating an environment, comprising:
a plurality of state devices generating state data indicative of a state of operation, wherein at least one state device is a digital media adapter to convert digital media for a non-IP enabled device; and
a processor;
a memory in electrical communication with the processor and including,
a plurality of modules, wherein one of the modules is a simulation module to generate a simulated model of an environment, and
a user interface to enable user communication and perform the method of,
reviewing a permission assigned to a user, and
limiting access to the modules based on the permission;
a database in electrical communication with the processor and having,
digital media stored thereon for distribution over the network, and
a media file server to access the digital media; and
a network interface in electrical communication with the processor to enable communication with the network.

22. The network system of claim 21, wherein the user interface of the memory further performs the method of,
enabling a user to access, based on permission, a module generating non-traceable statistics; and
allowing the user to retrieve the non-traceable statistics based on permission.

23. The network system of claim 21, wherein the memory includes a remote administration engine to enable remote user control.

24. The network system of claim 21, wherein the simulation module comprises,
collector agents to receive state data from state devices;
a simulation engine to receive the state data and generate recommendations; and
a control action module to receive recommendations and generate actions for state devices.

25. The network system of claim 21, wherein the simulation engine includes a scheduler agent for performing the method of,
receiving state data indicative of operation of a state device;
comparing the state data to a schedule; and
generating an output to notify a user of noncompliance with the schedule.

26. The network system of claim 21, wherein at least one state device is an IP enabled device to receive digital media.

27. A method for retrieving statistical data from a network, comprising:
assigning permissions to users;
limiting access by the users to modules at least partially resident within a server of a network based on the assigned permissions;
a data module at least partially resident within a server compiling statistical data relating to a residence corresponding to the network;
enabling a user to access the data module based on an assigned permission; and
allowing a user to retrieve the statistical data based on an assigned permission.

28. The method of claim 27, wherein the statistical data is not traceable to the residence and occupants of the residence.

29. The method of claim 27, wherein compiling statistical data relates to transactions performed by the data module.

30. The method of claim 27, wherein the statistical data is indicative of a profile of an occupant of the residence.

31. A computer readable medium comprising computer executable code for performing the method of retrieving statistical data from a network, comprising:
assigning permissions to users;
limiting access by the users to modules at least partially resident within a server of a network based on the assigned permissions;
a data module at least partially resident within a server compiling statistical data relating to a residence corresponding to the network;
enabling a user to access the data module based on an assigned permission; and
allowing a user to retrieve the statistical data based on an assigned permission.

32. The computer readable medium of claim 31, wherein the statistical data is not traceable to the residence and occupants of the residence.

33. The computer readable medium of claim 31, wherein compiling statistical data relates to transactions performed by the data module.

34. The computer readable medium of claim 31, wherein the statistical data is indicative of a profile of an occupant of the residence.

35. A method for notifying a user of noncompliance with a predetermined schedule having a plurality of events, comprising:
placing a state device in electrical communication with a network;
a server receiving over the network, state data corresponding to the state device and indicative of a scheduled event;
the server comparing the state data to the schedule to determine compliance with the schedule; and
generating a notification for the user indicating the schedule noncompliance.

36. The method of claim 35, wherein the state data is indicative of user operation of the state device.

37. The method of claim 35 further comprising displaying the notification on a user interface.

38. A computer readable medium having stored thereon computer instruction code for performing a method for notifying a user of noncompliance with a predetermined schedule having a plurality of events, comprising:
communicating with a state device;
receiving state data from the state device indicative of a scheduled event;
comparing the state data to the schedule to determine compliance with the schedule; and
generating a notification for the user indicating the schedule noncompliance.

39. The computer readable medium of claim 38, wherein the state data is indicative of user operation of the state device.

40. The computer readable medium of claim 38 further comprising displaying the notification on a user interface.

41. A server for communicating with state devices on a network and generating a simulation model of an environment, comprising:
a processor; and
a memory in electrical communication with the processor and comprising,:
collector agents to receive state data from corresponding state devices,
the state data indicative of the operation of the state devices,
a simulation engine comprising simulation agents, each simulation agent corresponding to a subsystem of the simulation model, the simulation engine to receive the state data, generate the simulation model, and generate recommendations based on predictions, and
a control action module comprising action agents, the control action module to receive the recommendations and generate commands for the state devices.

42. The server of claim 41, wherein the collector agents are further to generate a composite system state and wherein the simulation engine is to receive the composite system state.

43. The server of claim 41, wherein the memory further includes,
a rule tree; and
outcome experience,
wherein the simulation engine bases predictions and the simulation model on the rule tree and outcome experience.

44. The server of claim 41, wherein the memory further includes,
a schedule, and
a scheduler agent to review state data and compare events occurring in relation to the state devices with the schedule.
